(19) United States
(12) Patent Application Publication
(10) Pub. No.: US 2026/0196183 A1
(43) Pub. Date: Jul. 9, 2026

(54) HIGH-END DISPLAY FOR DISPLAYING DYNAMICALLY EVOLVING GENERATIVE ART

(71) Applicant: Layer, Inc., Los Angeles, CA (US)

(72) Inventors: Angelo Sotiracopoulos, Los Angeles, CA (US); Gilles Dubuc, Pérols (FR)

(73) Assignee: Layer, Inc., Los Angeles, CA (US)

(21) Appl. No.: 19/009,586

(22) Filed: Jan. 3, 2025

(51) Int. Cl. G09G 5/00; G06T 11/00

(52) U.S. Cl. CPC G09G 5/005; G06T 11/00; G09G 2360/145

(57) ABSTRACT

A square QLED display device exclusively displays generative and dynamically evolving art. The device incorporates a custom high-density mini LED backlight with a quantum dot layer to achieve superior color gamut and contrast ratio in a 1:1 form factor. Integrated millimeter-wave (mmWave) and other sensors enable audience and environment detection. The display further includes an integrated high-performance GPU for real-time generative art rendering. The display leverages a variety of inputs from sensors embedded in the display device, as well as randomization features embedded in the generative algorithms. These inputs and randomization features together enable the creation of a “living” artwork that continuously evolves and responds dynamically to its environment and context.

### FIELD

The present technology relates to a digital art display, and in particular to a high resolution digital display for displaying dynamic and perpetually evolving generative artwork.

### BACKGROUND

The medium for displaying art has seen a significant transformation, from static canvases to digital displays capable of showcasing diverse works of art. While traditional displays allow for art to be changed manually, they lack the capability to present evolving art—art that changes organically and in response to its environment. Moreover, traditional display devices have been designed with a focus on general-purpose applications, and are not configured for displaying high-quality generative and dynamic art. The limitations in visual quality, color gamut, and contrast ratio of these devices have hindered their adoption for artistic purposes. Further, while generative art has gained popularity, the hardware required to display such works, particularly at high resolutions and framerates, necessitates a connection to external computing devices, limiting usability and integration.

### DESCRIPTION OF THE DRAWINGS

FIG. 1 is a schematic block diagram of a generative display according to embodiments of the present technology.

FIG. 2 is a schematic representation of a generative display according to embodiments of the present technology.

FIG. 3 is a flowchart showing the steps in an artist content provider creating a generative art algorithm according to embodiments of the present technology.

FIG. 4 is a flowchart showing the steps in executing a generative art algorithm within the display according to embodiments of the present technology.

FIG. 5 is an illustration of the display displaying generative art according to embodiments of the present technology.

FIG. 6 is an illustration of the backside of the generative display according to embodiments of the present technology.

FIG. 7 is a schematic block diagram of a computing environment according to embodiments of the present technology.

### DETAILED DESCRIPTION

The present technology will now be described with reference to the figures, which in general relate to a square QLED display device for exclusively displaying generative and dynamically evolving art. The display incorporates a custom high-density mini LED backlight with a quantum dot layer to achieve superior color gamut and contrast ratio in a 1:1 form factor. Integrated millimeter-wave (mmWave) and other sensors enable audience and environment detection. The display further includes an integrated high-performance GPU for real-time generative art rendering.

The display is configured to show dynamically changing and perpetually evolving generative artwork. The system leverages a variety of inputs from sensors embedded in the display device, as well as randomization features embedded in the generative art algorithms. These inputs and randomization features together enable the creation of a “living” artwork that continuously and perpetually evolves and responds dynamically to its environment and context.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

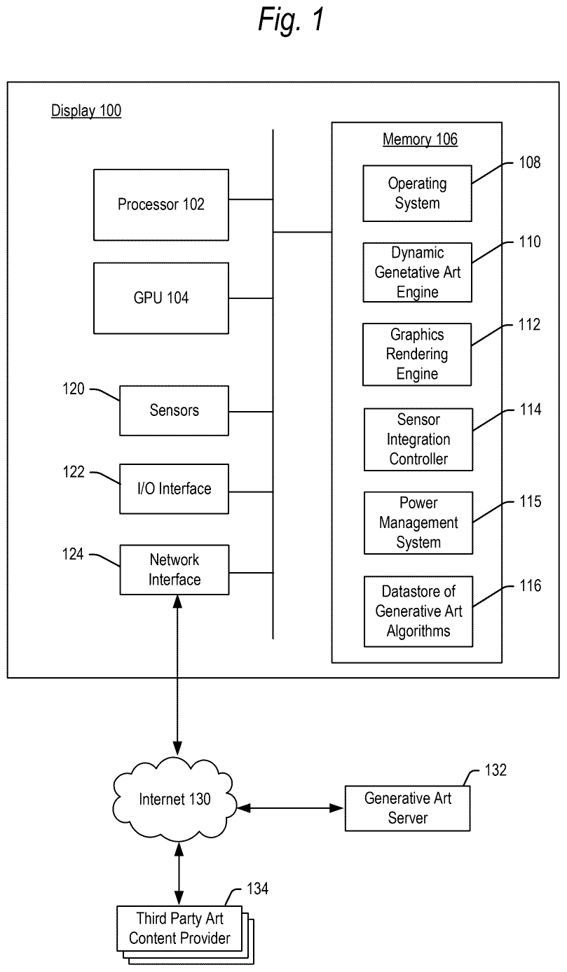

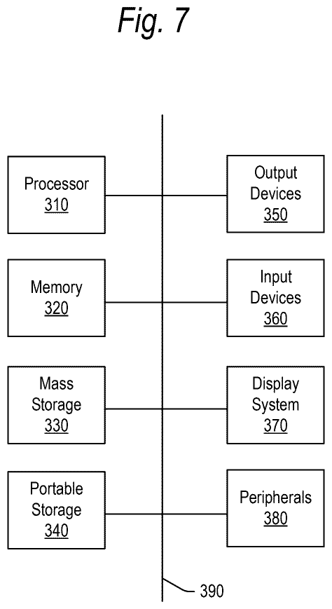

FIG. 1 is a schematic block diagram of a sample generative display 100 according to the present technology. A more detailed explanation of the composition of display 100 is described below with reference to FIG. 7, but in general, display 100 may be a quantum light-emitting diode (QLED)-type display. The display 100 may operate per organic light emitting diode (OLED) or other technologies in further embodiments. The display 100 may include a processor 102 configured to control the operations of display 100, as well as facilitate communications between various components within display 100. The processor 102 may include a standardized processor, a specialized processor, a microprocessor, an artificial intelligence (AI) processor or the like that may execute instructions for controlling display 100.

In accordance with further aspects of the present technology, display 100 may include an integrated graphics processing unit, or GPU, 104 dedicated to rendering high-quality visuals and graphics, including real-time generative art. The GPU 104 of the present technology is designed to deliver high-performance rendering capabilities tailored for real-time generative and dynamic art. The GPU 104 may include advanced parallel processing cores optimized for handling complex visual computations, ensuring smooth rendering of high-resolution, interactive art at frame rates exceeding, for example, 60 FPS, though the framerate may be higher or lower than that in further embodiments.

To align with the displays enhanced color gamut and contrast ratio, the GPU may incorporate specialized tone-mapping algorithms and support for HDR (High Dynamic Range) processing, ensuring accurate and vibrant color reproduction. Additionally, the GPU 104 may include hardware acceleration for machine learning inference, allowing it to process sensor data from mmWave as explained below. The hardware acceleration may further assist with machine learning as to ambient light and microphones in real-time, enabling seamless interaction between the displayed art and its environment. The GPU 104 may further integrate a custom memory hierarchy with high-bandwidth GDDR6 or GDDR6X RAM for rapid data access, ensuring minimal latency during complex art transformations. The display 100 may further include a thermal management system for managing the processor 102 and GPU 104 which is optimized for quiet operation, making it suitable for an art display. In the embodiment shown in FIG. 1, the processor 102 and GPU 104 are separate components, but in further embodiments the processor 102 and GPU 104 may be integrated together.

The display 100 may further include a memory 106 that may store algorithms that may be executed by the processor 102 and GPU 104. According to an example embodiment, the memory 106 may include RAM, ROM, cache, flash memory, a hard disk, and/or any other suitable storage component. As shown in FIG. 1, in one embodiment, the memory 106 may be a separate component in communication with the processor 102 and GPU 104, but the memory 106 may be integrated into the processor 102 and/or GPU 104 in further embodiments.

Memory 106 may store various software application programs executed by the processor 102 and/or GPU 104 for controlling the operation of the display 100. Such application programs may for example include an operating system 108, a dynamic generative art engine 110, a graphics rendering engine 112, a sensor integration controller 114 and a power management system 115. Each of these software components are explained in greater detail below. Display 100 may further include a datastore 116 for storing a selection of generative art algorithms. Display 100 further includes sensors 120, including for example an mmWave sensor, an input/output (I/O) interface 122 and a network interface 124. Each of these components is explained in greater detail below. Memory 106 may store additional algorithms in further embodiments.

The operating system 108 manages the hardware and software components of display 100, ensuring scheduling and execution of the software components without conflict and providing a user interface for users to interact with the display 100. The operating system 108 is comprised of a kernel that integrates and coordinates hardware and software components, including the GPU 104, sensors 120 and the display rendering components explained below. The operating system 108 further prioritizes low-latency graphical rendering, thus ensuring seamless display of the dynamic generative art. The operating system 108 also incorporates a content management framework, allowing users to upload and organize generative art files or algorithms, either locally or via a cloud-connected interface. The operating system 108 may perform additional functions in further embodiments.

The dynamic generative art engine 110 may perform a number of functions but in general is responsible for creating display-ready generative art for presentation on display 100. In embodiments, the dynamic generative art engine 110 receives generative art algorithms from artists via one or more remote sources described below. The generative art algorithms are created to display digital art which changes and evolves over time. One way in which the algorithms are configured to change the displayed art over time is to accept contextual input, for example from environmental and situational sensors embedded in display 100. The algorithms may further include randomization functions which change features of the displayed digital art in unpredictable and non-repeatable ways. This combination of context awareness and randomized variability produces a “living” artwork that evolves and perpetually changes the displayed generative art to continuously engage and entertain its audience.

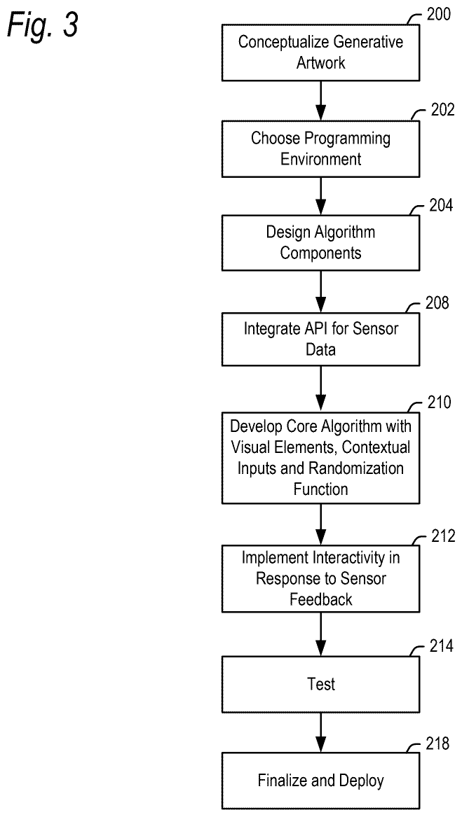

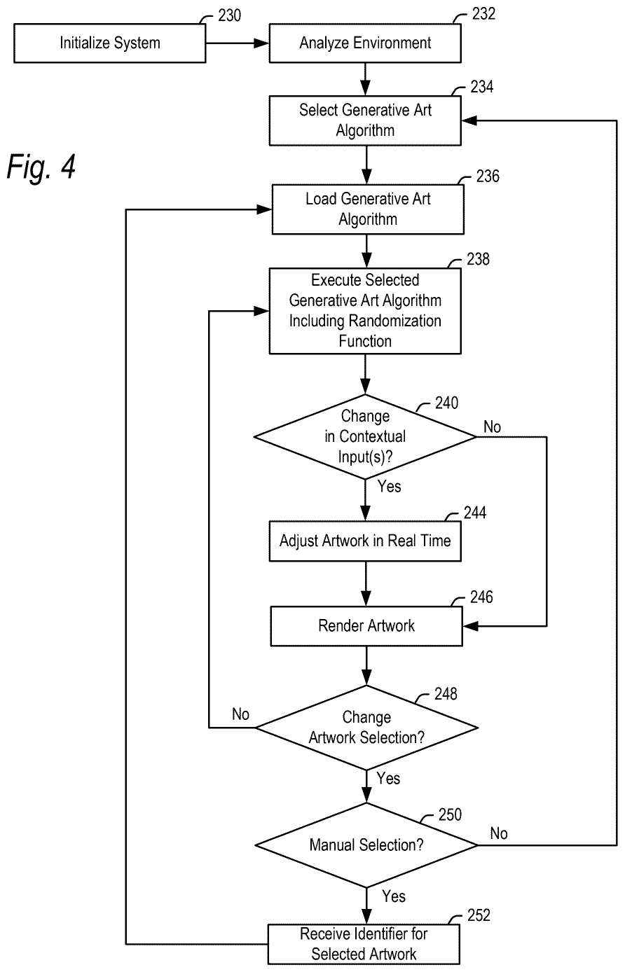

The creation of generative art algorithms and their use by the dynamic art engine 110 are explained below in detail with respect to the flowcharts of FIGS. 3 and 4. However, in general, artist content creators produce generative art algorithms which get processed by the dynamic art engine 110 for rendering on the display 100. Generative art algorithms from content creators may be loaded into memory 106 of the display 100 in a number of ways. As shown in FIG. 1, in one example, the display 100 is connected to a network 130 such as the Internet or local area network via the network interface 124. A generative art server 132 may be dedicated to serving displays 100 at multiple locations, and may be a central repository for generative art algorithms. The server 132 may receive generative art algorithms from artists and may download generative art algorithms to a display 100 in response to a request received from a curator of the display 100. Generative art algorithms may come from other remote locations, including for example one or more third party content providers 134, which provide content to the server 132 or directly to a display 100. Generative art algorithms may additionally or alternatively be loaded into datastore 116 of memory 106 from a flash drive or other portable storage device via the I/O interface 122.

User control of display 100 may be accomplished by a dedicated controller, or by a portable computing device such as a smartphone, tablet or laptop. Such control may include various tasks such as turning on and off the display, manually selecting a channel or specific artwork and/or making manual adjustments to the display 100. The dedicated controller or portable computing device may interact with the display 100 via the I/O interface 122 or the network interface.

As noted, the digital art displayed from a generative art algorithm may be customized to its display environment. This may be done in at least two ways. First, the general theme of a generative artwork may be classified into one of several categories that map to an ambiance of the room or location of the display 100 (referred to herein as display location). These classifications may include for example:
calm and serine;
energetic and vibrant;
introspective and thoughtful;
social and lively;
romantic and intimate;
mystical and mysterious;
professional and formal;
playful and fun;
minimalist and modern;
nature-inspired;
festive and seasonal; and
cultural and traditional.
   Other types of classifications and ambiances are possible. A display may be provided with different channels corresponding to these different categories. The generative artwork may be classified into one or more of these categories, either by the content provider or by the dynamic generative art engine 110, possibly implementing an AI platform as explained below. Depending on a selected channel, the engine 110 may select a generative art algorithm from that channel category.

The second way digital art displayed from a generative art algorithm may be customized to its display environment is by configuring the algorithm to receive real time contextual inputs at or related to a display environment. For example, the display 100 may include a number of sensors 120 for sensing parameters and characteristics of the display location. For example, the display 100 may include a millimeter-wave (mmWave) sensor 120 which can sense several characteristics with respect to people in the room. It can tell whether someone is in the room. It can tell the number of people in a room and their movements and behaviors. It can also provide biometric data for people in the room.

It is possible that the mmWave sensor 120 be omitted in further embodiments. In such embodiments, machine learning may further be used to deduce the room context based on the signal strength and device ID of nearby Bluetooth devices. This Bluetooth-based approach will either augment mmWave data or substitute it in embodiments where the mmWave sensor is omitted.

The display may include other types of sensors 120 as well, including for example sensors that measure the amount of light in the display location, temperature sensors, noise level sensors and a microphone. The display 100 may include other or alternative types of sensors 120 in further embodiments. The artist content providers may be provided with an API enabling them to program the generative art algorithm to accept input as to some or all of these sensor outputs. The generative art algorithm may be programmed to accept other, non-environmental inputs. For example, the dynamic generative art engine 110 may be configured to receive current events or other news via its connection to the Internet. The inputs received from any of the sensors 120 or the Internet is referred to herein as contextual input.

A generative art algorithm produced by a content provider may be customized in response to an API (for example provided by server 132 or a display 100) to receive real time contextual input from any of the above-described sources. Thus, upon execution by dynamic generative art engine 110 in display 100, the same generative art algorithm will produce a different digital artwork, depending on the contextual input received by the algorithm. As a simple example, unlike conventional computer displays, it is desirable to maintain the display brightness at the light level of the room. Thus, the brightness of the display 100 may be adjusted to match the light in the display location. As the light in the display location changes, where light is an input to the generative art algorithm, so too would the display brightness change. Generative art algorithms may be configured to receive as inputs a large number of contextual inputs, or relatively few contextual inputs.

The dynamic generative art engine 110 may customize and vary the displayed art in a wide variety of ways in response to different contextual inputs. It processes data from mmWave sensors, microphone, ambient light detectors and any other sensors 120 to adjust the content of the artwork in real time. For example, a generative art algorithm run by engine 110 may slow animations in a quiet setting, or it may create interactive art that reacts to audience movements. An artwork presented on display 100 may change or evolve in a great many other ways in response to contextual input.

The contextual input may be updated in real time. However, a user-defined sensitivity measure may be applied in determining whether to change the displayed art. For example, a curator may set the sensitivity level to high, meaning that even subtle changes in the contextual input result in changes to the artwork. Alternatively, the sensitivity level may be set to low, so that small changes in the contextual input do not result in changes to the artwork. The sensitivity measure may alternatively be set by default by the dynamic generative art engine 110.

Alternatively or additionally, the displayed digital artwork may be allowed to change periodically (only after passage of a set period of time) in response to changed contextual input. This allows the user to prevent the artwork from changing too frequently. The period, as well as the speed with which a digital artwork transitions in response to new contextual input, may be defined by a curator of the display, or set by default by the dynamic generative art engine 110.

The above system provides two layers of control over the content displayed on display 100. First, artist content providers are empowered to define how their generative artworks respond to specific contextual inputs. For example, an artwork may alter its visual elements or behavior depending on room brightness, number of people and their level of activity, or other detected conditions. This allows for artistic interpretation and customization across different environments. Second, the dynamic generative art engine 110 may control the content by selecting content that will display in a predefined and known way in response to contextual inputs.

It is a further feature of the present technology that artwork presented on display 100 from a given generative art algorithm may dynamically change in perpetuity (for the life of the display), never repeating a displayed image or video. This may be due in part to changing contextual inputs as described above. As another feature, the generative art algorithms may be programmed with a randomization function. In particular, algorithms may use a random seed generator to generate a random seed. Changing the random seed results in a different sequence of random numbers, which can then be used to change various aspects of the artwork, such as shapes, colors, positions, sizes, or patterns. The seed could be a static seed or evolving seed. Thus, the artwork generated by a given generative art algorithm may vary perpetually, independent of any changes due to contextual input.

Using the above features, the dynamic generative art engine 110 may select a generative art algorithm based on a determined classification (explained below with respect to the flowchart of FIG. 4). The engine 110 may then run the algorithm, using context input from the sensors 120 or other sources as called for by the algorithm. The result is a “living” artwork. Like a living organism, the artwork is affected by and responds to changes in its environment, perpetually evolving to continuously engage and entertain its audience.

The dynamic generative art engine 110 may further function as a content management service. The engine 110 may manage the download generative art algorithms from server 132 or a third-party content provider 134 and storage of the algorithms within the datastore 116 of memory 106. The content management function of the dynamic generative art engine 110 may further include the scheduling of content for display on display 100.

By executing the generative art algorithm, the dynamic generative art engine 110 generates a display-ready image or video file. The graphics rendering engine 112 is responsible for taking the display-ready file from the dynamic generative art engine 110 and rendering it as visual content and imagery on the screen of display 100. The graphics rendering engine 112 processes input data such as code for generative art and uses the GPU 104 to render high-resolution image frames at smooth (high) frame rates. The engine 112 operates through a rendering pipeline, which includes stages such as vertex processing (defining object shapes and positions), rasterization (converting shapes into pixels), and fragment processing (adding textures, colors, and lighting). In embodiments where the display 100 is a QLED, the graphics rendering engine 112 may further include advanced shader programs ensuring precise color reproduction and vivid contrast, leveraging the QLED display's quantum dot-enhanced capabilities for a high-quality visual experience.

The display 100 shown in FIG. 1 may further include a sensor integration controller 114 for receiving sensor feedback from sensors 120, and formatting the sensor feedback for use by the dynamic generative art engine 110. For example, the controller 114 may format sensor data to match algorithm inputs. The sensor integration controller 114 may further filter noise from the sensor data and/or normalize the data for use by the engine 110. The controller 114 may further monitor the operation of the various sensors 120.

The display 100 may further include a power management system 115. The power management system in the display is designed to optimize energy consumption while maintaining display quality. The system 115 may further implement a power saving mode where the system 115 can turn off power to the display, or dim the display, when the mmWave sensor 120 senses the display location is empty for a predetermined period of time.

As noted above, the processor 102 may be an artificial intelligence processor, for example implementing a large language model or other convolutional neural network. Artificial intelligence may be used to improve several aspects of the present technology. For example, artificial intelligence may assist the dynamic generative art engine 110 in classifying generative artwork into the different categories corresponding to room ambiance. Artificial intelligence may be used by the dynamic generative art engine 110 to analyze sensor feedback and select an optimized generative artwork for the room ambiance. Artificial intelligence may further aid the engine 110 in determining how the artwork evolves upon a change in contextual inputs. It is conceivable that the artificial intelligence may be used to create an entirely new generative art algorithm based on contextual inputs.

Artificial intelligence may further be used to assist the sensors such as the mmWave sensor 120 in analyzing the display location, people in the vicinity of the display 100 and their activities. Artificial intelligence can assist the dynamic generative art engine 110 and/or graphics rendering engine 112 to improve image quality in real-time, adjusting parameters like contrast and color balance for optimal viewing. Artificial intelligence may be used to improve the randomization function which may be embedded within generative art algorithms processed by the dynamic generative art engine 110. It is understood that artificial intelligence may be used to assist and improve the operation of other aspects of the present technology in further embodiments.

It is understood that the display 100 may include further software components in addition to those shown in FIG. 1 and described above in further embodiments.

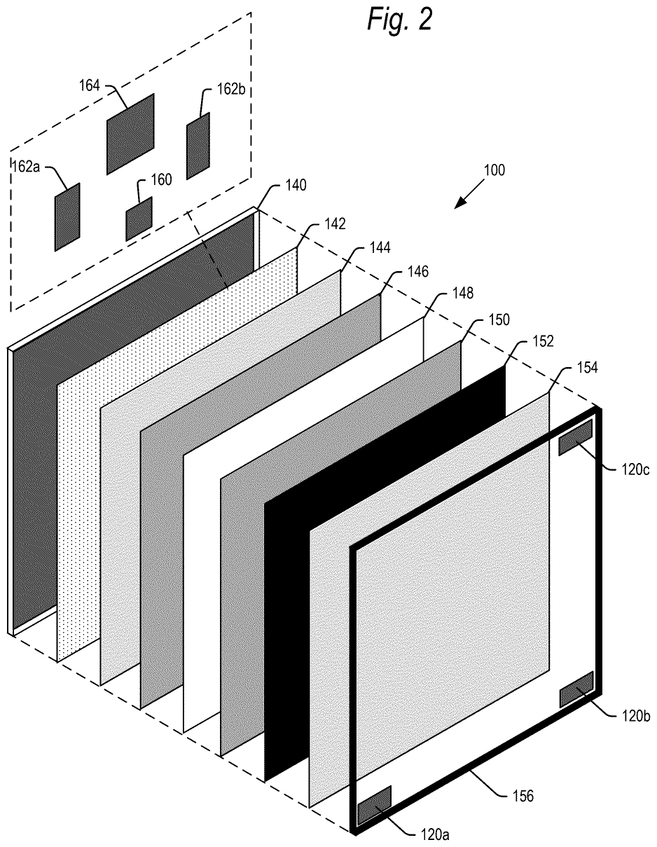

FIG. 2 is an exploded perspective view showing hardware layers of the display 100. As noted, in embodiments, the display may be a QLED display, but having several components customized to operate in a square 1:1 aspect ratio as explained below. Starting from the rearmost component, the display 100 may include a thermal conduction chassis 140 having integrated cooling structure. Further details of the cooling structure are described below with respect to FIG. 6, but in general, the thermal conduction chassis 140 may include a number of protruding surfaces to maximize surface area and to maximize passive heat conduction away from the active layers of the display 100. The chassis may include vents along one, two, three or all four sides for cooling airflow through the display 100.

An interior panel 142 may support various printed circuit boards including circuitry for controlling the operation of the display 100 as described below. These control units 160, 162, 164a and 164b are shown exploded from the display 100 but may be mounted on an interior or exterior surface of the panel 142.

The QLED display 100 may further include a backlight unit 144, which may include an array of LEDs that provide the display's illumination. These LEDs may emit blue light toward the quantum dot layer, explained below. In one embodiment, there may be a square array of 9216 mini LEDs, though there may be more or less LEDs than that in further embodiments.

The light guide plate, or light diffuser layer, 146 is positioned between the backlight unit 144 and the quantum dot layer 148. Its primary role is to uniformly distribute the light from the backlight across the entire surface of the display, ensuring even brightness and minimizing any hotspots or uneven lighting.

The quantum dot layer 148 receives blue light transmitted from the backlight unit 144 through the light diffuser layer 146. The quantum dot layer 148 contains nanoparticles that convert the blue light into highly pure red and green light, which, when combined, create the RGB color spectrum needed for the display 100. The quantum dot layer 148 has been customized for the present technology to have a square, 1:1 aspect ratio.

The next layer is a polarizer sheet 150. The polarizer sheet is used to reduce halo effects coming from the backlight. It selectively filters and aligns light travelling to the LCD layer (described below), reducing stray light and enhancing contrast and sharpness in the displayed image. By improving light control, it ensures deeper blacks, better color accuracy, and sharper transitions between bright and dark areas.

The open cell LCD layer 152 in the QLED display 100 is a thin, multi-layered structure that modulates light to create images. It consists of two glass substrates (one of which is shown at 154) that sandwich a liquid crystal layer, with electrodes to control the crystals' orientation and polarizers to manage light transmission. A color filter array assigns red, green, or blue to subpixels, combining to form full-color images. By dynamically adjusting the liquid crystals' alignment with electric fields, the layer controls brightness and color for each pixel, delivering sharp, vibrant visuals. As noted above, the layer 152 may be customized as in the other layers to have a square 1:1 aspect ratio.

As noted, the layer 154 may be a glass layer forming part of the LCD layer 152 and may form a front surface of the QLED display 100. It may be coated with one or more films to make the layer anti-glare, anti-reflective and anti-fingerprint, thereby optimizing viewing of the visuals formed by the LCD layer 152. The layer 154 may further be polarized to filter unwanted light from passing through. A front bezel 156 may provide an aesthetically pleasing look, and may seal the layers of the display 100 within the chassis 140.

As noted above, the QLED display 100 may further include a variety of control units and sensors. Controllers 160, 162, 164a, 164b may be mounted to the interior panel 142 and electrically coupled to the interior layers of the display 100. Controllers 160, 162a, 162b together may control the operation of the backlight layer 144. The separation of the controllers indicates separate printed circuit boards (PCBs). The FPGA-based controller 160 may be mounted on a first PCB and may be the master controller controlling the overall operation of the backlight layer 144. A sub-controller 162a may be mounted on a second PCB and may drive operation on a first half of the display (for example the left side). And a sub-controller 162b may be mounted on a third PCB and may drive operation on a second half of the display (for example the right side). It is understood that the backlight controller may be integrated together on a single PCB or divided onto PCBs in other ways in further embodiments.

The controllers 160, 162a and 162b together control the operation of the backlight layer 144. One of its main control functions is to minimize latency between the video signal it sends to the LCD layer 152 and the electrical signals it sends to the mini LED array of the backlight layer 144. Backlight controllers have conventionally been configured to control a 16:9 aspect ratio display. The controller 160, 162a and 162 have been customized for use with the square display 100 of the present technology.

The controller 164 may be a main controller for the display 100, containing an SoC (system on a chip) including the processor 102, GPU 104, and memory 106 mounted on a PCB. This PCB may house other supporting components, some of which are described below with respect to FIG. 7.

It is a feature of the present technology that the GPU 104 is mounted on a PCB within the display 100. In particular, the GPU 104 is a powerful GPU sufficient to support generative art, which requires real-time computation and rendering capabilities far beyond those used for static images or pre-rendered video. TVs and displays have had basic integrated GPUs in the past, but not high-end GPUs capable of rendering live art that makes heavy use of vertex and pixel shaders as does display 100. Devices that have been primarily acting as a display (like a TV, computer monitor or billboard) have not had GPUs that powerful with a high amount of shader units. It would not be possible to render the generative artworks of the present technology at a satisfactory framerate on entry-level GPUs that are conventionally found in displays. Displays attempting to render generative art have always required a connected external computer with a GPU via an input mode, such as HDMI or USB.

As noted, the display 100 may include a number of sensors 120. These sensors include mmWave sensor 120a, ambient light sensor 120b and microphone 120c. There may be more than one type of sensor in further embodiments. For example, there may be two light sensors in opposite corners of the display 100. These sensors are shown schematically by way of example in FIG. 2, and it is understood that these sensors may be positioned in a variety of locations (not obstructing a view of the art image/video presented on display 100). The display 100 may include other sensors in further embodiments.

As described above, all of the hardware layers and control devices of the present technology have been customized to provide a square display with a 1:1 aspect ratio. Outputting a square resolution natively is difficult, as most display hardware has been standardized on 16:9 resolutions. GPUs and display controllers in the past have been optimized for standard rectangular resolutions. Creating a square display necessitated custom firmware and hardware modifications to enable native square resolution output. The square footprint was only possible upon such modifications to allow the GPU 104 and other rendering components to operate natively at a square resolution.

Moreover, conventional devices that have included resized LCDs in the past have simply stretched a 16:9 image to the new aspect ratio, which introduces visual degradations and loss of pixel density. Providing a square footprint also required redesign of the backlight layer 144, the quantum dot layer 148 and LCD layer 152. This redesign allowed the artwork to work at exactly the same resolution as the physical output in the present technology.

FIG. 3 is flowchart describing the steps an artist would take to generate a generative art algorithm. In step 200, the artist conceptualizes the artwork and defines the artistic vision. In step 202, the artist chooses the programming environment, such as for example p5.js or Three.js. In step 204, the artist designs algorithm components. The artist may define layers and attributes and establish rules defining the generation of the artwork. Here, the artist may also set up the randomization function. In step 208, the artist may integrate sensor data from an API at display 100. As noted above, an API may be generated, for example at the generative art server 132 or display 100, for use by artists designing generative art for presentation on display 100. That API may grant the artist access to a display 100 or server 132 to enable the artist to identify sensors and to define the sensor inputs that the artist will include in the generative art algorithm

In step 210, the artist may develop the core algorithm, including generative functions for visual elements of the artwork, inputs for contextual data and integration of a randomization function. In step 212, the artist may implement interactivity in response to the sensor feedback. Here, the artist can define how the artwork will change for given contextual inputs. In step 214, the artist can test the generative artwork, possibly testing to ensure real-time rendering capability and testing its response to different contextual data. In step 218, the artist may finalize the generative art algorithm and deploy it. As noted above, generative art algorithms may be stored on a third-party art content provider site 134, on the generative art server 132 or downloaded directly to the datastore 116 of a display 100. It is conceivable that a sample of the artwork would be uploaded to a catalogue, for example stored on generative art server 132.

As noted above, some or all of the steps of FIG. 3 may be performed by an artificial intelligence processor in further embodiments.

FIG. 4 is a flowchart showing how the generative art engine 110 within the display 100 selects and processes a generative art algorithm including supplying sensor input for use in the generative art algorithm to adjust the generative artwork. In step 230, the system may be initialized, for example by turning on the display 100, booting up software engines such as the generative art engine 110, and activating the sensors 120. In step 232, the sensors may analyze the display location, receiving feedback on parameters such as the number of people and their activity, light levels, the temperature, the noise level within the room, etc. The received contextual data may be processed by the sensor integration controller 114 into uniform data that may be consumed by the generative art algorithms.

In step 234, the dynamic generative art engine 110 may analyze the sensor input to classify the ambiance of the display location. The engine 110 may then select an artwork from the category corresponding to the ambiance category. Where there are multiple artworks in a determined category, the engine 110 may prioritize selections by artist-provided metatags, system parameters (curator preferences, rotation schedules, or content usage history), and randomized or weighted algorithms, ensuring a diverse and engaging rotation of artworks while adhering to the classified mood. Other factors may be considered when prioritizing an artwork for selection from a given category. As noted above, artificial intelligence may also be used in this process. Once a generative art algorithm is selected, it may be retrieved in step 236 from the datastore 116 in memory 106, or it may be downloaded from a remote site (server 132 or third-party content provider 134).

In step 238, the engine 110 may execute the selected generative art algorithm, randomized per its randomization function to ensure the display will not simply be a repeat of past displays. In step 240, the dynamic generative art engine 110 analyzes the contextual input (in real time) to determine if there are changes to the contextual input. If so, the presentation of the artwork may change or evolve in step 244 in response to the change in contextual inputs. As noted above, changes in the artwork may be subject to a sensitivity measure or a period of time. If no changes to the contextual input in step 240, the adjustment step 244 may be skipped.

In step 246, the artwork may be rendered by the graphics rendering engine 112. The engine 110 may check in step 248 whether a curator or other user wishes to change the artwork. If not, the flow may then return to step 238 to continue execution of the selected generative art algorithm.

If on the other hand a change is requested in step 248, the engine 110 may check in step 250 whether the curator or user wishes to make a manual selection of an artwork. If not, the flow returns to step 234 and a new generative art algorithm is selected (keeping in mind content selection history so that the same artwork is not selected). If a manual selection is received in step 250, an identifier for the selected artwork is received in step 252, and the flow returns to step 236 to load the newly selected generative art algorithm.

As noted above, some or all of the steps of FIG. 4 may be performed by an artificial intelligence processor by itself or in communication with the dynamic generative art engine 110 in further embodiments.

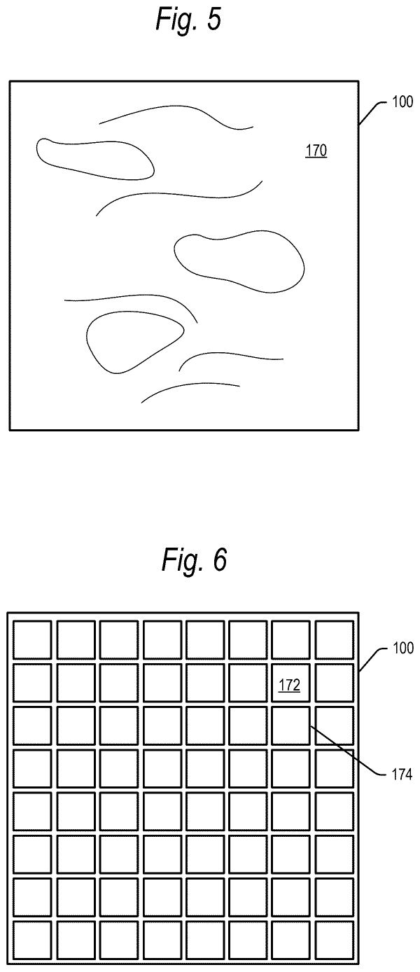

FIG. 5 is a front view of a display 100 presenting artwork 170 created from a generative art algorithm as explained above. It is understood that any type of art may be presented on display 100 in accordance with the present technology. The display 100 may be hung on a wall by picture hooks or the like, or suspended in air with string or wire anchored to a wall or ceiling.

FIG. 6 is a rear view of a display 100 illustrating the thermal conduction chassis 140. The chassis 140 comprises a number of raised surfaces 172 defined by lower elevation valleys 174. The raised surfaces 172 and valleys 174 together provide a larger surface area over which to dissipate heat from the display 100. In one embodiment, the raised surfaces 172 may be raised between 0.5 inches and 2 inches relative to the valleys 174, though this height differential may be more or less that this in further embodiments. In embodiments, the raised surfaces 172 may be square and have a length and width of between 1 inch to 5 inches, though these dimensions may be larger or smaller than this in further embodiments. The thermal conduction chassis may be made of a thermally conductive material, such as aluminum, copper, graphite or stainless steel. Other materials are possible. While the raised surfaces are shown as square, the raised surface may be other geometric shapes in further embodiments, including rectangular and circular.

While a passive cooling system as described above may be preferable for its lack of noise, a fan unit may be included in further embodiments. Fan units with low noise emission may be used. Another option for cooling is an ionization-based air flow system without moving parts. Such units are available from Ventiva Inc., Fremont CA.

FIG. 7 illustrates an exemplary computing system 300 that may be display 100 or other server used to implement an embodiment of the present technology. The computing system 300 of FIG. 7 includes one or more processors 310 and main memory 320. Main memory 320 stores, in part, instructions and data for execution by processor unit 310. Main memory 320 can store the executable code when the computing system 300 is in operation. The computing system 300 of FIG. 7 may further include a mass storage device 330, portable storage medium drive(s) 340, output devices 350, user input devices 360, a display system 370, and other peripheral devices 380.

The components shown in FIG. 7 are depicted as being connected via a single bus 390. The components may be connected through one or more data transport means. Processor unit 310 and main memory 320 may be connected via a local microprocessor bus, and the mass storage device 330, peripheral device(s) 380, portable storage medium drive(s) 340, and display system 370 may be connected via one or more input/output (I/O) buses.

Mass storage device 330, which may be implemented with a solid state drive, a magnetic disk drive or an optical disk drive, is a non-volatile storage device for storing data and instructions for use by processor unit 310. Mass storage device 330 can store the system software for implementing embodiments of the present invention for purposes of loading that software into main memory 320.

Portable storage medium drive(s) 340 operate in conjunction with a portable non-volatile storage medium, such as a external hard drive, external SSD or USB stick, to input and output data and code to and from the computing system 300 of FIG. 7. The system software for implementing embodiments of the present invention may be stored on such a portable medium and input to the computing system 300 via the portable storage medium drive(s) 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 7 includes output devices 350. Suitable output devices include speakers, printers, network interfaces, and monitors. Where computing system 300 is part of a mechanical client device, the output device 350 may further include servo controls for motors within the mechanical device.

Display system 370 may include a liquid crystal display (LCD) or other suitable display device. Display system 370 receives textual and graphical information, and processes the information for output to the display device.

Peripheral device(s) 380 may include any type of computer support device to add additional functionality to the computing system. Peripheral device(s) 380 may include a modem or a router.

The components contained in the computing system 300 of FIG. 7 are those typically found in computing systems that may be suitable for use with embodiments of the present invention and are intended to represent a broad category of such computer components that are well known in the art. Thus, the computing system 300 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, MacOS, FreeBSD, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, an SSD, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In summary, one embodiment of the present technology relates to a square display for presenting generative art, the display comprising: a backlight layer customized for use with a square footprint; one or more processors integrated within the display; a graphics processing unit (GPU) integrated within the display, the GPU configured to render generative art; and a light sensor configured to match a lighting in a location of the display to optimized lighting for presentation of the generative art.

In another example, the present technology relates to a display for presenting generative art, the display comprising: one or more contextual sensors; one or more processors configured to execute code to: run a generative art algorithm to generate a generative artwork; render the artwork; alter the artwork in response to input from the one or more contextual sensors; and alter the artwork in response to a randomization function included in the generative art algorithm.

In a further example, the present technology relates to a display for presenting generative art, the display comprising: one or more contextual sensors; one or more artificial intelligence (AI) processors configured to execute code to: generate a generative art algorithm; run the generative art algorithm to generate a generative artwork; render the artwork; alter the artwork using AI in response to input from the one or more contextual sensors; and alter the artwork in response to a randomization function included in the generative art algorithm; wherein altering the artwork in response to input from the one or more contextual sensors and altering the artwork in response to the randomization function results in artwork which changes for the life of the display, never repeating a displayed image or video.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

We claim:

1. A square display for presenting generative art, the display comprising:
a backlight layer customized for use with a square footprint;
one or more processors integrated within the display;
a graphics processing unit (GPU) integrated within the display, the GPU configured to render generative art; and
a light sensor configured to match a lighting in a location of the display to optimized lighting for presentation of the generative art.

2. The square display of claim 1, further comprising an mmWave sensor within the display for sensing a number of people present in the location of the display and an activity of a person of the one or more people.

3. The square display of claim 2, further comprising a software engine configured to change the generative art presented on the display upon a change in sensor reading from at least one the light sensor and the mmWave sensor.

4. The square display of claim 1, further comprising an LCD layer customized to work with a square display.

5. The square display of claim 1, further comprising a backlight controller, wherein the backlight controller is customized to work with the square backlight layer.

6. The square display of claim 1, further comprising a thermally conductive frame including elevated surfaces surrounded by valleys for heat conduction away from the display.

7. A display for presenting generative art, the display comprising:
one or more contextual sensors;
one or more processors configured to execute code to:
run a generative art algorithm to generate a generative artwork;
render the artwork;
alter the artwork in response to input from the one or more contextual sensors; and
alter the artwork in response to a randomization function included in the generative art algorithm.

8. The display of claim 7, wherein altering the artwork in response to input from the one or more contextual sensors and altering the artwork in response to the randomization function results in artwork which changes for the life of the display, never repeating a displayed image or video.

9. The display of claim 7, wherein the generative art algorithm generates an artwork that is classified into a category.

10. The display of claim 9, wherein the generative art algorithm is selected because its classification matches an ambiance in the location of the display.

11. The display of claim 7, wherein the generative art algorithm discovers the inputs from the one or more sensors in the display via an API.

12. The display of claim 7, wherein the one or more sensors comprise a light sensor.

13. The display of claim 7, wherein the one or more sensors comprise an mmWave sensors.

14. The display of claim 7, wherein the one or more sensors comprise a microphone.

15. The display of claim 7, wherein the display is a quantum light-emitting diode (QLED)-type display.

16. A display for presenting generative art, the display comprising:
one or more contextual sensors;
one or more artificial intelligence (AI) processors configured to execute code to:
generate a generative art algorithm;
run the generative art algorithm to generate a generative artwork;
render the artwork;
alter the artwork using AI in response to input from the one or more contextual sensors; and
alter the artwork in response to a randomization function included in the generative art algorithm;
wherein altering the artwork in response to input from the one or more contextual sensors and altering the artwork in response to the randomization function results in artwork which changes for the life of the display, never repeating a displayed image or video.

17. The display of claim 16, wherein the generative art algorithm generates an artwork that is classified into a category using AI.

18. The display of claim 17, wherein the generative art algorithm is selected because its classification matches an ambiance in the location of the display.

19. The display of claim 16, wherein the display is a quantum light-emitting diode (QLED)-type display.
